(19) United States
(12) Patent Application Publication
(10) Pub. No.: US 2006/0194502 A1
(43) Pub. Date: Aug. 31, 2006

(54) Manufacturing method of image display device and manufacturing apparatus of image display device

(76) Inventors: Masakuni Osoegawa, Fukaya-shi (JP); Yuuji Kuwabara, Hiratsuka-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/415,310

(22) Filed: May 2, 2006

Related U.S. Application Data
(63) Continuation of application No. PCT/JP04/17012, filed on Nov. 16, 2004.

(30) Foreign Application Priority Data
Nov. 18, 2003 (JP) 2003-387957

(51) Int. Cl. H01J 9/26; H01J 9/32

(52) U.S. Cl. 445/25

(57) ABSTRACT

The apparatus includes a vacuum chamber capable of accommodating a to-be-processed substrate, which is at least one of the front substrate and the back substrate, an evacuation mechanism which evacuates an inside of the vacuum chamber, a processing electrode which is disposed to be opposed to the to-be-processed substrate within the vacuum chamber, an electrical-conductivity-imparting process mechanism which imparts electrical conductivity to the to-be-processed substrate, and an electric field application mechanism which applies an electric field between the to-be-processed substrate, to which the electrical conductivity is imparted by the electrical-conductivity-imparting process mechanism, and the processing electrode.

### CROSS-REFERENCE TO RELATED APPLICATIONS

This is a Continuation Application of PCT Application No. PCT/JP2004/017012, filed Nov. 16, 2004, which was published under PCT Article 21(2) in Japanese.

This application is based upon and claims the benefit of priority from prior Japanese Patent Application No. 2003-387957, filed Nov. 18, 2003, the entire contents of which are incorporated herein by reference.

### BACKGROUND OF THE INVENTION

1. Field of the Invention

The present invention relates to a method of manufacturing an image display device and an apparatus for manufacturing the image display device, and more particularly to a manufacturing method and a manufacturing apparatus capable of improving withstand voltage characteristics of an image display device.

2. Description of the Related Art

In recent years, as a next-generation image display device, a planar image display device has been developed, wherein a great number of electron emission elements are disposed to be opposed to an image display surface. There are a variety of types of electron emission elements. Basically, the electron emission elements make use of electron emission by an electric field. An image display device using the electron emission elements is generally called “field emission display (FED)”. Of the FEDs, an image display device, which uses surface-conduction electron emission elements, is called “surface-conduction electron-emitter display (SED)”. The “FED” is a general term covering “SED”.

In general, the FED includes a front substrate and a back substrate, which are opposed to each other with a predetermined gap. Peripheral portions of these substrates are coupled to each other via a frame-shaped side wall, and thus a vacuum envelope is constructed. The inside of the vacuum envelope is kept at a high vacuum of about 10⁻⁴ Pa or less. A plurality of support members are provided between the substrates in order to bear an atmospheric pressure load acting on the back substrate and front substrate.

A phosphor screen including phosphor layers, which emit red, blue and green light, is formed on the inner surface of the front substrate. In addition, in order to obtain practical display characteristics, an aluminum foil, which is called “metal back”, is formed on the phosphor screen. Furthermore, in order to adsorb a gas remaining within the vacuum envelope or a gas emitted from each substrate, a metal film having gas adsorbing characteristics, which is called “getter film”, is deposited by evaporation (“getter flash”) on the metal back.

A great number of electron emission elements, which emit electrons for exciting the phosphor layers to emit light, are provided on the inner surface of the back substrate. In addition, a great number of scan lines and signal lines are formed in a matrix and are connected to the electron emission elements.

In the FED, an anode voltage is applied to the image display surface including the phosphor screen and the metal back. Electron beams, which are emitted from the electron emission elements, are accelerated by the anode voltage and caused to impinge upon the phosphor layers. Thus, the phosphor layers emit light. Thereby, an image is displayed on the image display surface. In this case, it is desired that the anode voltage be set at several kV at the least, and at 10 kV or more if possible.

In the FED, the gap between the front substrate and the back substrate can be set at about 1 to 3 mm. Compared to cathode-ray tubes (CRTs) which are currently used as displays of TVs and computers, remarkable reduction in weight and thickness can be achieved.

However, the gap between the front substrate and the back substrate cannot greatly be increased from the standpoint of resolution and electron emission efficiency, and the gap needs to be set at about 1 to 3 mm. Consequently, in the FED, a strong electric field is inevitably produced in the small gap between the front substrate and the back substrate, and there arises a problem of discharge (dielectric breakdown) between both substrates.

If a discharge occurs, a current of 100 A or more flows instantaneously and may cause damage or degradation of the electron emission elements or the image display surface. In addition, the driving circuit may be damaged due to discharge. These problems are generally referred to as damage by discharge. Such damage is not tolerable for products. In order to put the FED to practical use, damage due to discharge has to be suppressed. It is very difficult, however, to completely suppress the discharge.

On the other hand, there is a possible measure to reduce the magnitude of discharge, rather than preventing the occurrence of discharge, so that the effect of discharge on the electron emission elements, even if such discharge occurs, may be ignored (reduced). A technique relating to this concept is disclosed in Jpn. Pat. Appln. KOKAI Publication No. 2000-311642, for instance. This document discloses a technique wherein notches are cut in the metal back provided on the image display surface and a zigzag pattern, for example, is formed. Thereby, the effective inductance/resistance of the phosphor surface is increased. In addition, Jpn. Pat. Appln. KOKAI Publication No. 10-326583 discloses a technique wherein the metal back is divided. Further, Jpn. Pat. Appln. KOKAI Publication No. 2000-251797 discloses a technique wherein the divided part is coated with an electrically conductive material in order to suppress surface creeping discharge at the divided part.

Even if these techniques are used, however, it is difficult to completely suppress damage due to discharge.

In general, the voltage at which discharge occurs varies from case to case. In addition, there is such a case that discharge occurs after the passage of a long time. To suppress discharge means to completely prevent occurrence of discharge at the time of applying anode voltage, or to reduce the probability of discharge to a practically tolerable level. In the description below, the potential difference between the anode and cathode, which can be applied while discharge is being suppressed, is referred to as “withstand voltage”.

There are various factors that cause discharge. First, discharge may be triggered by electron emission from a minute projection or foreign matter on the cathode side. Second, discharge may be triggered when fine particles or parts thereof, which adhere to the cathode or anode, are separated and caused to impinge upon the opposed surface. In particular, in the FED, the metal back and the getter film, which are thin films with low strength, are formed on the phosphor screen. A part of such films may be separated to trigger discharge.

The getter film is formed on the metal back as an evaporation-deposited film by fixing a metal with high gas adsorption characteristics, such as Ba or Ti, on a metal base plate serving as a base plate for a getter, and heating the metal base plate. At this time, there may be cases where part of the metal base plate and part of the getter electrode are melted in an evaporation step in which the metal base plate is heated, and the molten part may fall on the front substrate and back substrate. This part may become a source of discharge, and may become a main factor which increases discharge.

There is generally known a method called “conditioning” which improves withstand voltage. The details of this method are described, for example, on page 302 of “Handbook of Discharge” (Ohmsha, 1998). In this method, a potential difference is caused between the opposed surfaces, and withstand voltage is improved. In the conditioning, discharge may be caused in some cases, and not in other cases. In a narrow sense of the term, spark conditioning, in which discharge (spark) is caused, may be called “conditioning” in some cases. The mechanism of improvement in withstand voltage by the spark conditioning has not been made clear. Possible reasons may include melting and removal of a discharge source, such as a minute projection or foreign matter, due to a spark, and removal of an adhering fine particle due to an electric field.

For example, in CRTs, such a process has widely been performed that a pulse voltage, which is about four times higher than an operation voltage, is applied between the electrodes of the electron gun, and discharge is caused several thousand times. This corresponds to the spark conditioning.

The conditioning in which no spark is caused also has an effect of improving withstand voltage. Even in this case, it is desirable to produce an as high as possible potential difference between the opposed surfaces. However, such a high potential difference may unintentionally cause a spark, and damage due to the spark is inevitable. The same effect of the spark conditioning cannot be expected from the conditioning in which no spark is caused.

In the case of the FED, however, if the spark conditioning is performed, the image display surface or the electron emission element may be damaged or degraded. Thus, it is not possible to simply use this method.

Taking the above into account, in order to prevent foreign matter, which may cause discharge, from entering the FED, air blowing or ultrasonic dry cleaning is performed, or the manufacture is conducted within a clean room. However, although foreign matter deposited on the substrate can be removed by air blow, it is not possible to remove foreign matter adhering (firmly adhering) to the substrate. Even if foreign matter is successfully removed by air blow, fine foreign matter floating in the air may re-adhere to the substrates before the front substrate and back substrate are put in a vacuum sealing apparatus, and entrance of fine foreign matter cannot be prevented.

Since getter flash can be performed only in a vacuum, the front substrate and back substrate are contaminated with particles occurring at this time. It is thus necessary to remove foreign matter adhering to the front substrate and back substrate within the vacuum sealing apparatus.

Possible methods for improving withstand voltage, other than the conditioning, may include optimization of the material, structure and manufacturing process, cleaning of the manufacturing environment, washing, and air blow. However, with these methods alone, it is difficult to increase the withstand voltage up to a desirable value, and there has been a demand for the advent of withstand voltage improving methods with higher effects. Moreover, from the standpoint of cost reduction, such methods as extremely increasing the degree of cleanness or completely removing fine particles are not desirable.

As has been described above, in the FED, countermeasures against discharge are important. However, if the anode voltage, which is the operation voltage, or the gap between the front substrate and back substrate, is increased with a view to suppressing discharge, the display performance, such as luminance or resolution, may deteriorate and it becomes difficult to obtain a sufficient display performance for the product. Besides, there is no means for removing foreign matter, which adheres to the front substrate and back substrate when the substrates are input in the vacuum sealing apparatus, or fine particles occurring at the time of getter flash.

### BRIEF SUMMARY OF THE INVENTION

The present invention has been made in consideration of the above-described problems, and the object of the invention is to provide a method of manufacturing an image display device and an apparatus for manufacturing the image display device, which can achieve excellent withstand voltage characteristics and improve display performance and reliability.

According to a first aspect of the present invention, there is provided a manufacturing method of an image display device including a front substrate having an image display surface, and a back substrate having electron emission elements which emit electrons toward the image display surface, comprising:

an electrical-conductivity-imparting process step of imparting electrical conductivity to a to-be-processed substrate, which is at least one of the front substrate and the back substrate, within a vacuum atmosphere;

an electric field process step of disposing a major surface of the to-be-processed substrate with the electrical conductivity to be opposed to a processing electrode, and applying an electric field between the to-be-processed substrate and the processing electrode; and

a sealing step of sealing together the front substrate and the back substrate following the electric field process step in a state in which the front substrate and the back substrate are disposed to be opposed to each other within the vacuum atmosphere.

According to a second aspect of the present invention, there is provided a manufacturing apparatus of an image display device including a front substrate having an image display surface, and a back substrate having electron emission elements which emit electrons toward the image display surface, comprising:

a vacuum chamber capable of accommodating a to-be-processed substrate, which is at least one of the front substrate and the back substrate;

an evacuation mechanism which evacuates an inside of the vacuum chamber;

a processing electrode which is disposed to be opposed to the to-be-processed substrate within the vacuum chamber;

an electrical-conductivity-imparting process mechanism which imparts electrical conductivity to the to-be-processed substrate; and

an electric field application mechanism which applies an electric field between the to-be-processed substrate, to which the electrical conductivity is imparted by the electrical-conductivity-imparting process mechanism, and the processing electrode.

According to the manufacturing method of an image display device and the manufacturing apparatus of an image display device having the above-described structures, electrical conductivity is imparted to a to-be-processed substrate in a vacuum atmosphere, and an electric field process is performed by applying an electric field between the to-be-processed substrate with electrical conductivity and a processing electrode. Thereby, the substrate can get rid of factors of generation of discharge, irrespective of whether the factors of generation of discharge, such as foreign matter or projections on the major surface of the to-be-processed substrate, are electrically conductive or not. By using the to-be-processed substrate that is subjected to the electric field process, it becomes possible to manufacture an image display device with excellent withstand voltage characteristics and improved display performance and reliability.

### BRIEF DESCRIPTION OF THE SEVERAL VIEWS OF THE DRAWING

FIG. 1 is a perspective view that schematically shows an example of an FED, which is manufactured by a manufacturing method and a manufacturing apparatus according to an embodiment of the present invention;

FIG. 2 is a view that schematically shows a cross-sectional structure of the FED, taken along line A-A in FIG. 1;

FIG. 3 is a cross-sectional view that schematically shows a manufacturing apparatus of an image display device according to an embodiment of the invention;

FIG. 4 is a cross-sectional view that schematically shows a manufacturing apparatus of an image display device according to another embodiment of the invention;

FIG. 5 is a flow chart for describing a first manufacturing method of the image display device according to the embodiment of the invention;

FIG. 6 is a flow chart for describing a second manufacturing method of the image display device according to the embodiment of the invention;

FIG. 7 is a flow chart for describing a third manufacturing method of the image display device according to the embodiment of the invention;

FIG. 8 is a flow chart for describing a fourth manufacturing method of the image display device according to the embodiment of the invention; and

FIG. 9 is a flow chart for describing a fifth manufacturing method of the image display device according to the embodiment of the invention.

### DETAILED DESCRIPTION OF THE INVENTION

A manufacturing method of an image display device and a manufacturing apparatus of an image display device according to an embodiment of the present invention will now be described with reference to the accompanying drawings. An FED having surface-conduction electron emitters is described as the image display device that is manufactured by the present manufacturing method and manufacturing apparatus.

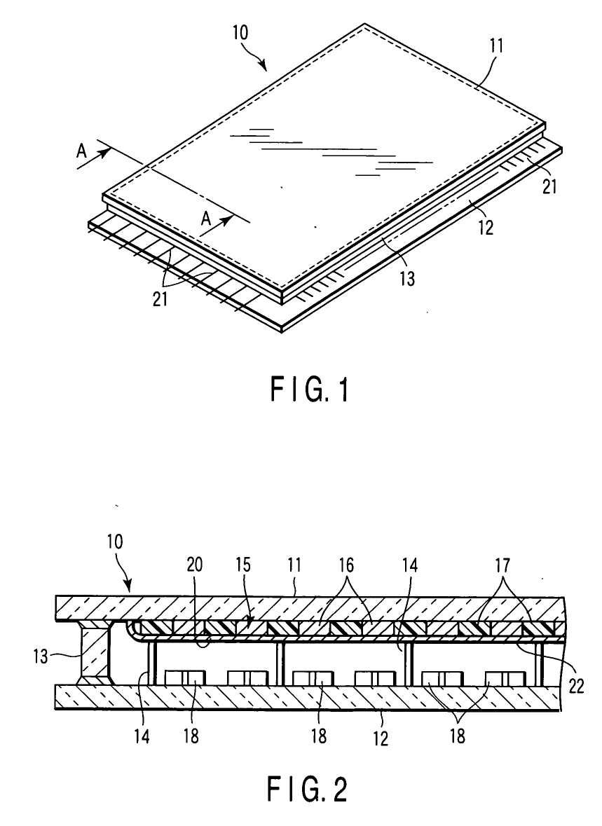

As is shown in FIG. 1 and FIG. 2, the FED includes a front substrate 11 and a back substrate 12, which are disposed to be opposed to each other with a gap of 1 to 2 mm. Each of the front substrate 11 and back substrate 12 is formed of a rectangular glass plate with a thickness of about 1 to 3 mm. Peripheral parts of the front substrate 11 and back substrate 12 are coupled via a rectangular frame-shaped side wall 13. Thereby, a planar rectangular vacuum envelope 10, the inside of which is kept at a high vacuum of about 10⁻⁴ Pa, is constructed.

The vacuum envelope 10 includes a plurality of spacers 14 which are provided within the inside thereof and bear an atmospheric pressure load acting on the front substrate 11 and back substrate 12. Each spacer 14 may have a plate shape, a columnar shape, etc.

The front substrate 11 includes an image display surface on the inner surface thereof. Specifically, the image display surface is composed of a phosphor screen 15, a metal back 20 disposed on the phosphor screen 15, and a getter film 22 disposed on the metal back 20.

The phosphor screen 15 includes phosphor layers 16 which emit red, green and blue light, and black light absorption layers 17 arranged in a matrix. The phosphor layers 16 may be formed in stripes or in dots. The metal back 20 is formed of an aluminum film, etc., and functions as an anode electrode. The getter film 22 is formed of a metal film having gas adsorption characteristics, and adsorbs a gas remaining within the vacuum envelope 10 and a gas released from each substrate.

The back substrate 12 includes surface-conduction type electron emission elements 18 on the inner surface thereof. The electron emission elements 18 function as electron sources that excite the phosphor layers 16 of the phosphor screen 15. Specifically, the plural electron emission elements 18 are arranged in a plurality of columns and a plurality of rows on the back substrate 12 in association with individual pixels, and emit electron beams to the associated phosphor layers 16. Each electron emission element 18 comprises an electron emission part (not shown) and a pair of element electrodes which apply a voltage to the electron emission part. A great number of wiring lines 21 for applying potential to the electron emission elements 18 are provided in a matrix on the inner surface of the back substrate 12, and end portions of the wiring lines 21 are led out of the vacuum envelope 10.

In this FED, at the time of operation for displaying an image, an anode voltage is applied to the image display surface including the phosphor screen 15 and metal back 20. Electron beams, which are emitted from the electron emission elements 18, are accelerated by the anode voltage and caused to impinge on the phosphor screen 15. Thereby, the phosphor layers 16 of the phosphor screen 15 are excited to emit lights of associated colors. In this manner, a color image is displayed on the image display surface.

Next, a manufacturing apparatus for manufacturing the FED with the above-described structure is described.

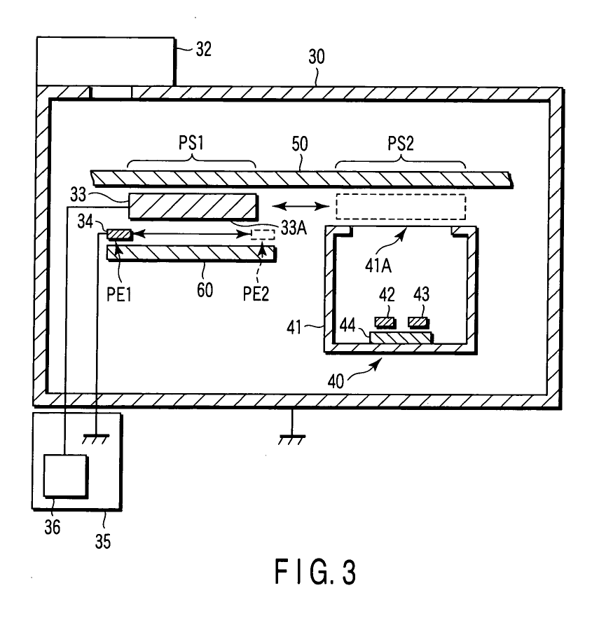

As is shown in FIG. 3, the manufacturing apparatus comprises a vacuum chamber 30, an evacuation mechanism 32, a processing electrode 34, an electric field application mechanism 35 and an electrical-conductivity-imparting process mechanism 40. The vacuum chamber 30 is formed of a vacuum process container which can accommodate a to-be-processed substrate 33. The to-be-processed substrate 33 is at least one of the front substrate 11, which has the image display surface on its major surface, and the back substrate 12, which has the electron emission elements 18 on its major surface.

A substrate transfer mechanism 50, which transfers the to-be-processed substrate 33, is provided within the vacuum chamber 30. The substrate transfer mechanism 50 transfers the to-be-processed substrate 33 over a range including an electric field process position PS1 for subjecting the to-be-processed substrate 33 to an electric field process, and an electrical-conductivity-imparting process position PS2 for subjecting the to-be-processed substrate 33 to an electrical-conductivity-imparting process. The electric field process position PS1 is set at a position facing the processing electrode 34. The electrical-conductivity-imparting process position PS2 is set at a position facing the electrical-conductivity-imparting process mechanism 40.

The evacuation mechanism 32 evacuates the inside of the vacuum chamber 30, and is composed of, for example, an evacuation pump that is connected to the vacuum chamber 30. The processing electrode 34 is provided within the vacuum chamber 30, and is disposed to be substantially in parallel to a major surface 33A of the to-be-processed substrate 33 and to be able to face the major surface 33A with a predetermined gap. The processing electrode 34, which is employed here, is formed, for example, in an elongated rectangular shape and has a width substantially equal to the width of the to-be-processed substrate 33 and a length less than the length of the to-be-processed substrate 33.

An electrode moving mechanism 60 is provided within the vacuum chamber 30. The electrode moving mechanism 60 supports the processing electrode 34 and moves the processing electrode 34 in its length direction while the processing electrode 34 is being opposed to the to-be-processed substrate 33. The electrode moving mechanism 60 reciprocally moves the processing electrode 34 between a first standby position PE1 and a second standby position PE2, which are located outside the electric field process position PS1, where the to-be-processed substrate 33 is positioned, and which are not opposed to the to-be-processed substrate 33.

The electric field application mechanism 35 applies an electric field between the to-be-processed substrate 33 and the processing electrode 34 within the vacuum chamber 30. Specifically, the electric field application mechanism 35 connects the processing electrode 34 to a ground and includes a power supply 36 which applies a predetermined voltage to the to-be-processed substrate 33. The vacuum chamber 30 is connected to a ground potential which is equal to the potential of the processing electrode 34.

The electrical-conductivity-imparting process mechanism 40 imparts electrical conductivity to the to-be-processed substrate 33. Specifically, the electrical-conductivity-imparting process mechanism 40 comprises a cover 41, an electrically conductive film material 42, a getter film material 43 and a heating mechanism 44. The cover 41 includes an opening 41A that is so formed as to face the to-be-processed substrate 33 which is set at the electrical-conductivity-imparting process position PS2. The electrically conductive film material 42 and the getter film material 43 are provided at positions facing the opening 41A within the cover 41. The heating mechanism 44 may adopt a radio-frequency heating method or a resistance heating method. The heating mechanism 44 heats the electrically conductive film material 42 and the getter film material 43.

To be more specific, the electrically conductive film material 42 and heating mechanism 44 function as an electrically conductive film forming device which evaporates the electrically conductive film material toward the major surface 33A of the to-be-processed substrate 33 within the vacuum atmosphere and forms an electrically conductive film. On the other hand, the getter film material 43 and heating mechanism 44 function as a getter film forming device which evaporates the getter film material toward the major surface 33A of the to-be-processed substrate 33 within the vacuum atmosphere and forms a getter film.

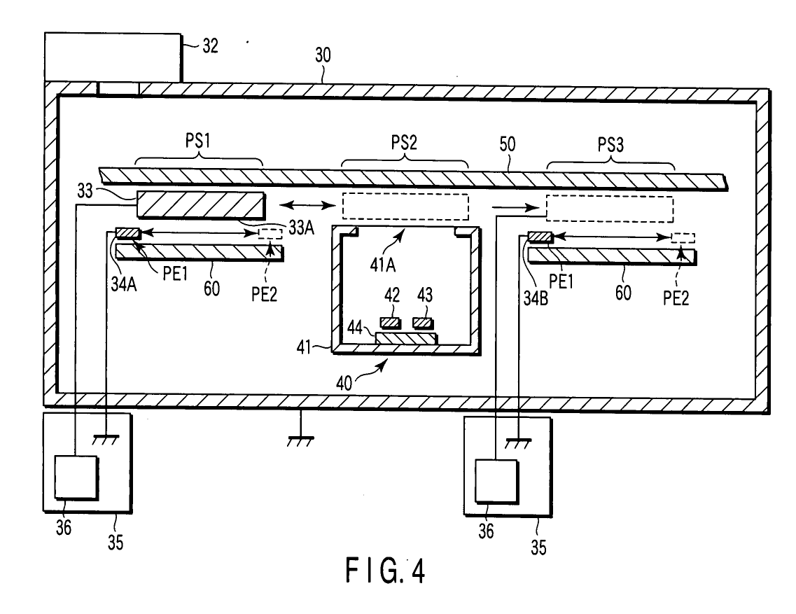

In addition, the manufacturing apparatus may also be constructed as shown in FIG. 4. Specifically, this manufacturing apparatus includes, like the apparatus shown in FIG. 3, the vacuum chamber 30, evacuation mechanism 32, electric field application mechanism 35 and electrical-conductivity-imparting process mechanism 40, and further includes a first processing electrode 34A and a second processing electrode 34B. The structural components common to those of the manufacturing apparatus shown in FIG. 3 are denoted by like reference numerals, and a detailed description thereof is omitted.

The substrate transfer mechanism 50, which is provided within the vacuum chamber 30, transfers the to-be-processed substrate 33 over a range including a first electric field process position PS1 for subjecting the to-be-processed substrate 33 to an electric field process, an electrical-conductivity-imparting process position PS2 for subjecting the to-be-processed substrate 33 to an electrical-conductivity-imparting process, and a second electric field process position PS3 for subjecting the to-be-processed substrate 33 to an electric field process. The first electric field process position PS1 is set at a position facing the first processing electrode 34A. The electrical-conductivity-imparting process position PS2 is set at a position facing the electrical-conductivity-imparting process mechanism 40. The second electric field process position PS3 is set at a position facing the second processing electrode 34B.

The first processing electrode 34A and second processing electrode 34B are both disposed to be substantially in parallel to the major surface 33A of the to-be-processed substrate 33 and to be able to face the major surface 33A with a predetermined gap. Each of the first processing electrode 34A and second processing electrode 34B, which are employed here, is formed, for example, in an elongated rectangular shape and has a width substantially equal to the width of the to-be-processed substrate 33 and a length less than the length of the to-be-processed substrate 33.

The first processing electrode 34A and second processing electrode 34B are respectively supported by electrode moving mechanisms 60. Each electrode moving mechanism 60 reciprocally moves the associated one of the first processing electrode 34A and second processing electrode 34B between a first standby position PE1 and a second standby position PE2, which are located outside the first and second electric field process positions PS1, PS3, where the to-be-processed substrate 33 is positioned, and which are not opposed to the to-be-processed substrate 33.

The electrical-conductivity-imparting process mechanism 40, which is provided between the first and second electric field process positions PS1 and PS3, imparts electrical conductivity to the to-be-processed substrate 33. This electrical-conductivity-imparting process mechanism 40, like the electrical-conductivity-imparting process mechanism shown in FIG. 3, has the functions of the electrically conductive film forming device and the getter film forming device.

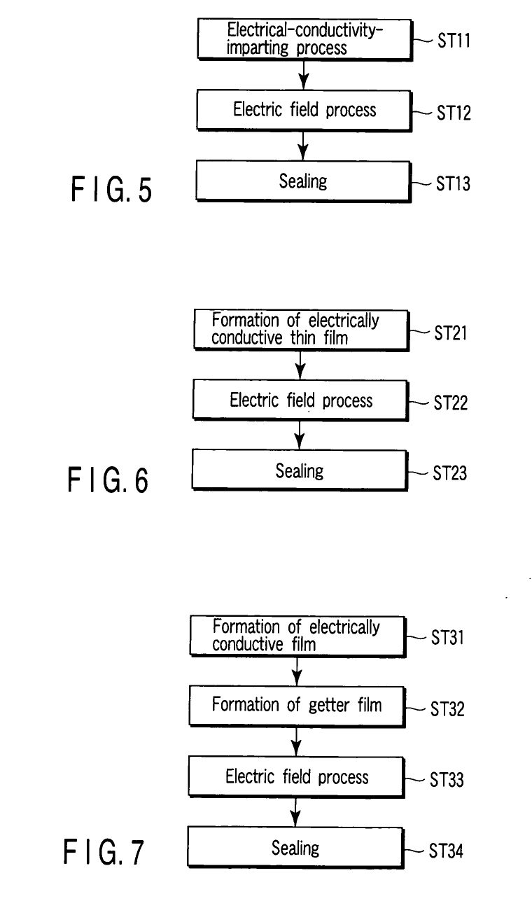

Next, a first manufacturing method for manufacturing the FED with the above-described structure is described with reference to a flow chart of FIG. 5.

To start with, there are prepared a front substrate 11 having the image display surface including the phosphor screen 15 and metal back 20, and a back substrate 12 having the electron emission elements 18. Within a vacuum atmosphere, an electrical-conductivity-imparting process is performed to impart electrical conductivity to the to-be-processed substrate 33, which is at least one of the front substrate 11 and back substrate 12 (ST11).

Assume now that at least the electrical-conductivity-imparting process (ST11) and a subsequent electric field process (ST12) are performed by using the manufacturing apparatus shown in FIG. 3. Specifically, the evacuation mechanism 32 is operated to evacuate the vacuum chamber 30 to a desired degree of vacuum. Thereby, a vacuum atmosphere is created within the vacuum chamber 30.

The to-be-processed substrate 33 is transferred into the vacuum chamber 30 by the substrate transfer mechanism 50 and disposed at the electrical-conductivity-imparting process position PS2. At this time, the to-be-processed substrate 33 is set at the electrical-conductivity-imparting process position PS2 such that its major surface 33A is opposed to the opening 41A of the cover 41 of the electrical-conductivity-imparting mechanism 40. In the case where the to-be-processed substrate 33 is the front substrate 11, its major surface having the image display surface is disposed to be opposed to the electrical-conductivity-imparting mechanism 40. In the case where the to-be-processed substrate 33 is the back substrate 12, its major surface having the electron emission elements 18 is disposed to be opposed to the electrical-conductivity-imparting mechanism 40.

Electrical conductivity is imparted to the to-be-processed substrate 33 by the electrical-conductivity-imparting mechanism 40. In the electrical-conductivity-imparting mechanism 40, the heating mechanism 44 heats and evaporates the electrically conductive film material 42, and an electrically conductive film is formed on the major surface 33A of the to-be-processed substrate 33. Thereby, electrical conductivity is imparted to the to-be-processed substrate 33. Alternatively, the heating mechanism 44 heats and evaporates the getter film material 43, and a getter film is formed on the major surface 33A of the to-be-processed substrate 33. Thereby, electrical conductivity is imparted to the to-be-processed substrate 33. Any other method may be used if electrical conductivity is imparted to at least the major surface of the to-be-processed substrate 33. Hence, the factors of generation of discharge, such as non-conductive foreign matter, dust, etc. remaining on the major surface 33A of the to-be-processed substrate 33, can be made electrically conductive.

Subsequently, the major surface 33A of the to-be-processed substrate 33, which has electrical conductivity, is subjected to an electric field process (ST12). Specifically, within the vacuum chamber 30, the to-be-processed substrate 33 is transferred by the substrate transfer mechanism 50 and set at the electric field process position PS1. At this time, the to-be-processed substrate 33 is disposed at the electric field process position PS1 such that its major surface 33A is opposed to the processing electrode 34 with a predetermined gap from the processing electrode 34. In addition, at this time, the processing electrode 34 is set at the first standby position PE1 and is not opposed to the to-be-processed substrate 33 that is set at the electric field process position PS1.

The to-be-processed substrate 33 is electrically connected to the power supply 36 of the electric field application mechanism 35, and the processing electrode 34 is electrically connected to the ground. The power supply 36 applies a predetermined voltage to the to-be-processed substrate 33. The voltage, which is applied from the power supply 36, is so set as to produce a positive or negative potential difference between the to-be-processed substrate 33 and the processing electrode 34. Thereby, an electric field is generated between the to-be-processed substrate 33 and processing electrode 34.

After the electric field is generated, the electrode moving mechanism 60 moves the processing electrode 34 from the first standby position PE1 toward the second standby position PE2 at a fixed speed. At this time, the processing electrode 34 moves in the length direction of the to-be-processed substrate 33 in the state in which the processing electrode 34 is opposed to the major surface 33A of the to-be-processed substrate 33 with a predetermined gap. In this manner, the to-be-processed substrate 33 and the processing electrode 34 are relatively moved, and the processing electrode 34 scans the entire surface of the to-be-processed substrate 33 while performing the electric field process on the major surface 33A of the to-be-processed substrate 33.

When the processing electrode 34 moves beyond to-be-processed substrate 33 and the reaches the second standby position PE2, the movement of the processing electrode 34 is stopped and the application of voltage to the to-be-processed substrate 33 is turned off.

By this electric field process, the to-be-processed substrate 33 is processed with the electric field and the factors of generation of discharge, which are present on the to-be-processed substrate 33, are eliminated. Specifically, foreign matter, or the like, which remains on the to-be-processed substrate 33 and is made electrically conductive, can be adsorbed to the processing electrode 34 and removed, and useless projections and portions with low adhesion of the metal back, etc., which are formed during the fabrication of the to-be-processed substrate 33, can be removed.

Following the end of the electric field process, when the processing electrode 34 reaches the position where the processing electrode 34 is not opposed to the to-be-processed substrate 33, the application of voltage is stopped, and the factors of generation of discharge, such as foreign matter or projections, which are adsorbed on the processing electrode 34, can be held on the processing electrode 34 and can be prevented from re-adhering to the to-be-processed substrate 33.

In this example, the processing electrode 34 is moved only in one direction from the first standby position PE1 to the second standby position PE2, and the electric field process is performed. It is also possible to perform the electric field process while reciprocally moving the processing electrode 34 between the first standby position PE1 and the second standby position PE2, and to finish the electric field process after the processing electrode 34 is moved to the first standby position PE1. In this case, when the to-be-processed substrate 33, on which the electric field process is completed, is moved toward the electrical-conductivity-imparting process position PS2 (past the position facing the second standby position PE2), the to-be-processed substrate 33 does not pass over the processing electrode 34 after the electric field process.

In short, it is desirable that the processing electrode 34, after the electric field process, should stand by at a position not facing the transfer path, through which the to-be-processed substrate 33, on which the electric field process is completed, is moved. In the case where the to-be-processed substrate 33, on which the electric field process is completed, is transferred past the position facing the first standby position PE1, the processing electrode 34 should stand by at the second standby position PE2. In the case where the to-be-processed substrate 33, on which the electric field process is completed, is transferred past the position facing the second standby position PE2, the processing electrode 34 should stand by at the first standby position PE1. Thereby, the factors of generation of discharge can more surely be prevented from re-adhering to the to-be-processed substrate 33 from the processing electrode 34.

After the electric field process, the front substrate 11 and back substrate 12 are disposed to be opposed to each other within the vacuum atmosphere and are sealed together (ST13). Specifically, the to-be-processed substrate 33 is transferred to a sealing position (not shown) by the substrate transfer mechanism 50 in the state in which the to-be-processed substrate 33 is kept in the vacuum atmosphere without exposure to outside air. The front substrate 11 and back substrate 12, which are transferred to the sealing position, are coupled via the frame-shaped side wall 13 in the state in which their major surfaces are opposed to each other. Thus, the vacuum envelope 10 is formed, and the FED is completed. The sealing of the front substrate 11 and back substrate 12 may be performed within the same vacuum chamber as with the above-described electric field process, or within another vacuum chamber that communicates with this vacuum chamber in the vacuum state.

According to the above-described first manufacturing method, it is possible to remove the factors of generations of discharge, such as foreign matter adhering to the front substrate 11 and back substrate 12 before the front substrate 11 and back substrate 12 are put in the vacuum chamber 30, and useless projections, etc., which are formed during the fabrication of the front substrate 11 and back substrate 12.

In the electric field process, factors of generation of discharge, which are not made electrically conductive, cannot be removed. Thus, before the electric field process, the to-be-processed substrates (front substrate 11 and back substrate 12) are subjected to the electrical-conductivity-imparting process. Thereby, factors of generation of discharge, which have not been made electrically conductive, are made electrically conductive and can be removed by the electric field process.

Hence, triggering factors of generation of discharge can be eliminated, and the FED with enhanced withstand voltage characteristics can be obtained. In particular, the electric field process for the front substrate 11 and back substrate 12 is performed within the vacuum chamber 30 and then the vacuum envelope 10 is formed without exposing these substrates to the outside air. Thus, there is no possibility of re-adhering of dust in the air to the substrates, and initial discharge and discharge over a long time period can be suppressed.

As a result, it is possible to prevent damage and degradation of the image display surface and electron emission elements and damage to the driving circuit due to discharge, and to improve the reliability of the FED and to increase the lifetime of the FED. At the same time, the anode potential can be set at a high level, and the FED with high brightness and high display performance can be obtained.

In the above-described first manufacturing method, the to-be-processed substrate 33, which is at least one of the prepared front substrate 11 and back substrate 12, is immediately transferred to the electrical-conductivity-imparting process position PS2 and subjected to the electrical-conductivity-imparting process (ST11). Alternatively, prior to the electrical-conductivity-imparting process, the to-be-processed substrate 33 may be transferred to the electric field process position PS1 and subjected to the electric field process. Thereby, factors of generation of discharge, which are electrically conductive at the time the to-be-processed substrate 33 is put in the vacuum chamber 30, can be removed, and the withstand voltage characteristics can further be improved.

In the case where this electric field process is additionally performed prior to the electrical-conductivity-imparting process, in the manufacturing apparatus shown in FIG. 3, the to-be-processed substrate 33 is first subjected to the electric field process at the electric field process position PS1. Then, the to-be-processed substrate 33 is subjected to the electrical-conductivity-imparting process at the electrical-conductivity-imparting process position PS2. Once again, the to-be-processed substrate 33 is subjected to the electric field process at the electric field process position PS1. According to the manufacturing apparatus shown in FIG. 3, it should suffice if only one unit of the electric field process mechanism including the processing electrode is provided. Therefore, the apparatus structure can be simplified and reduced in size.

In the manufacturing apparatus shown in FIG. 4, the to-be-processed substrate 33 is first subjected to the electric field process at the first electric field process position PS1 by the first processing electrode 34A. Then, the to-be-processed substrate 33 is subjected to the electrical-conductivity-imparting process at the electrical-conductivity-imparting process position PS2. Subsequently, the to-be-processed substrate 33 is subjected to the electric field process at the second electric field process position PS3 by the second processing electrode 34B. According to the manufacturing apparatus shown in FIG. 4, the processing mechanisms are arranged within the apparatus in the order corresponding to the process steps. Thus, the processes can be performed by transferring the to-be-processed substrate 33 in one direction. Since it is possible to successively process a plurality of to-be-processed substrates 33, the manufacturing yield can be improved and the manufacturing cost can be reduced.

Next, a second manufacturing method for manufacturing the FED with the above-described structure is described with reference to a flow chart of FIG. 6. A detailed description of the same steps as have been described in connection with the first manufacturing method is omitted here.

To start with, there are prepared a front substrate 11 having the image display surface including the phosphor screen 15 and metal back 20, and a back substrate 12 having the electron emission elements 18. Within a vacuum atmosphere, an electrically conductive thin film is formed on the major surface of the front substrate 11 (ST21).

Specifically, the evacuation mechanism 32 is operated to evacuate the vacuum chamber 30 to a desired degree of vacuum. The front substrate 11 is transferred into the vacuum chamber 30 by the substrate transfer mechanism 50. The front substrate 11 is set at the electrical-conductivity-imparting process position PS2. At this time, at the electrical-conductivity-imparting process position PS2, the front substrate 11 is disposed such that its major surface having the image display surface is opposed to the opening 41A of the cover 41 of the electrical-conductivity-imparting process mechanism 40.

In the electrical-conductivity-imparting process mechanism 40, the heating mechanism 44 heats and evaporates the electrically conductive film material. 42 or getter film material 43, and a thin film with electrical conductivity, which is composed of an electrically conductive film or a getter film, is formed on the major surface of the front substrate 11. Thereby, factors of generation of discharge, such as non-conductive foreign matter, dust, etc. remaining on the major surface of the front substrate 11, can be made electrically conductive.

Subsequently, within the vacuum chamber 30, the front substrate 11 is transferred by the substrate transfer mechanism 50 and set at the electric field process position PS1. The electrically conductive thin film, which is formed on the major surface of the front substrate 11, is disposed to be opposed to the processing electrode 34. Further, a potential difference is applied between the front substrate 11 and the processing electrode 34, and an electric field is generated. Thus, the major surface of the front substrate 11 having the electrically conductive thin film is subjected to the electric field process (ST22). Thereby, factors of generation of discharge, which adhere to the major surface of the front substrate 11 when the front substrate 11 is put in the vacuum chamber 30, are removed. In addition, factors of generation of discharge, which adhere to the major surface of the front substrate 11, such as dust occurring in the electrically conductive thin film forming step (ST21) and substance floating in the vacuum chamber 30, can be removed.

After the electric field process, the front substrate 11 and back substrate 12 are disposed to be opposed to each other within the vacuum atmosphere and are sealed together (ST23). Specifically, the front substrate 11 is transferred to a sealing position (not shown) by the substrate transfer mechanism 50 in the state in which the front substrate 11 is kept in the vacuum atmosphere without exposure to outside air. The front substrate 11 and back substrate 12, which is transferred to the sealing position, are coupled via the frame-shaped side wall 13 in the state in which their major surfaces are opposed to each other. Thus, the vacuum envelope 10 is formed, and the FED is completed.

According to the above-described second manufacturing method, like the first manufacturing method, it is possible to remove the factors of generations of discharge, irrespective of the presence/absence of electrical conductivity, such as foreign matter adhering to the front substrate 11 before the front substrate 11 is put in the vacuum chamber 30, and useless projections, etc., which are formed during the fabrication of the front substrate 11.

Hence, the FED with enhanced withstand voltage characteristics can be obtained. It is possible to prevent damage and degradation of the image display surface and electron emission elements and damage to the driving circuit due to discharge, and to improve the reliability of the FED and to increase the lifetime of the FED. At the same time, the anode potential can be set at a high level, and the FED with high brightness and high display performance can be obtained.

In the above-described second manufacturing method, the electrically conductive film or getter film is used for the formation of the electrically conductive thin film. The main purpose of the film formation is to make electrically conductive the factors of generation of discharge. Thus, needless to say, a film of any kind of material may be used if the factors of generation of discharge are made electrically conductive. If a film with excellent withstand voltage characteristics or gas adsorption characteristics can be used, it becomes possible to provide an FED with improved performance and excellent withstand voltage characteristics.

Next, a third manufacturing method for manufacturing the FED with the above-described structure is described with reference to a flow chart of FIG. 7. A detailed description of the same steps as have been described in connection with the first manufacturing method is omitted here.

To start with, there are prepared a front substrate 11 having the image display surface including the phosphor screen 15 and metal back 20, and a back substrate 12 having the electron emission elements 18. Within a vacuum atmosphere, an electrically conductive film is formed on the major surface of the front substrate 11 (ST31).

Specifically, the evacuation mechanism 32 is operated to evacuate the vacuum chamber 30 to a desired degree of vacuum. The front substrate 11 is transferred into the vacuum chamber 30 by the substrate transfer mechanism 50. The front substrate 11 is set at the electrical-conductivity-imparting process position PS2. At this time, at the electrical-conductivity-imparting process position PS2, the front substrate 11 is disposed such that its major surface having the image display surface is opposed to the electrical-conductivity-imparting process mechanism 40. In the electrical-conductivity-imparting mechanism 40, the heating mechanism 44 heats and evaporates the electrically conductive film material 42, and an electrically conductive film is formed on the major surface of the front substrate 11.

Subsequently, in the vacuum atmosphere, a getter film is formed on the electrically conductive film of the front substrate 11 (“getter flash”) (ST32). Specifically, in the electrical-conductivity-imparting mechanism 40, the heating mechanism 44 heats and evaporates the getter film material 43, and a getter film is formed on the electrically conductive film of the front substrate 11 that is situated at the electrical-conductivity-imparting process position PS2. Thereby, factors of generation of discharge, such as non-conductive foreign matter, dust, etc. remaining on the major surface of the front substrate 11, can be made electrically conductive.

Subsequently, within the vacuum chamber 30, the front substrate 11 is transferred by the substrate transfer mechanism 50 and set at the electric field process position PS1. The electrically conductive film, which is formed on the major surface of the front substrate 11, is disposed to be opposed to the processing electrode 34. Further, a potential difference is applied between the front substrate 11 and the processing electrode 34, and an electric field is generated. Thus, the major surface of the front substrate 11 having the electrically conductive film is subjected to the electric field process (ST33). Thereby, factors of generation of discharge, which adhere to the major surface of the front substrate 11 when the front substrate 11 is put in the vacuum chamber 30, are removed. In addition, factors of generation of discharge, which adhere to the major surface of the front substrate 11, such as dust occurring in the electrically conductive thin film forming step (ST31) and getter film forming step (ST32) and substance floating in the vacuum chamber 30, can be removed.

After the electric field process, the front substrate 11 and back substrate 12 are disposed to be opposed to each other within the vacuum atmosphere and are sealed together (ST34). Thus, the vacuum envelope 10 is formed, and the FED is completed.

According to the above-described third manufacturing method, the same advantages as with the second manufacturing method can be obtained.

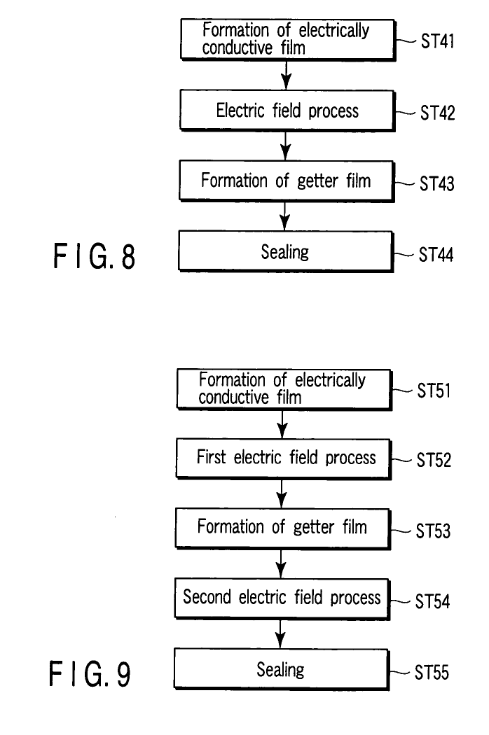

Next, a fourth manufacturing method for manufacturing the FED with the above-described structure is described with reference to a flow chart of FIG. 8. A detailed description of the same steps as have been described in connection with the first manufacturing method is omitted here.

To start with, there are prepared a front substrate 11 having the image display surface including the phosphor screen 15 and metal back 20, and a back substrate 12 having the electron emission elements 18. Within a vacuum atmosphere, an electrically conductive film is formed on the major surface of the front substrate 11 (ST41).

Specifically, the vacuum chamber 30 is evacuated to a desired degree of vacuum. The front substrate 11 is transferred into the vacuum chamber 30 by the substrate transfer mechanism 50. The front substrate 11 is set at the electrical-conductivity-imparting process position PS2. At this time, at the electrical-conductivity-imparting process position PS2, the front substrate 11 is disposed such that its major surface having the image display surface is opposed to the electrical-conductivity-imparting process mechanism 40. In the electrical-conductivity-imparting mechanism 40, the heating mechanism 44 heats and evaporates the electrically conductive film material 42, and an electrically conductive film is formed on the major surface of the front substrate 11. Thereby, factors of generation of discharge, such as non-conductive foreign matter, dust, etc. remaining on the major surface of the front substrate 11, can be made electrically conductive.

Subsequently, within the vacuum chamber 30, the front substrate 11 is transferred by the substrate transfer mechanism 50 and set at the electric field process position PS1. The electrically conductive film, which is formed on the major surface of the front substrate 11, is disposed to be opposed to the processing electrode 34. Further, a potential difference is applied between the front substrate 11 and the processing electrode 34, and an electric field is generated. Thus, the major surface of the front substrate 11 having the electrically conductive film is subjected to the electric field process (ST42). Thereby, factors of generation of discharge, which adhere to the major surface of the front substrate 11 when the front substrate 11 is put in the vacuum chamber 30, are removed. In addition, factors of generation of discharge, which adhere to the major surface of the front substrate 11, such as dust occurring in the electrically conductive film forming step (ST41) and substance floating in the vacuum chamber 30, can be removed.

Subsequently, in the vacuum atmosphere, a getter film is formed on the electrically conductive film of the front substrate 11 (“getter flash”) (ST43). Specifically, the front substrate 11 is transferred by the substrate transfer mechanism 50 and disposed at the electrical-conductivity-imparting process position PS2. In the electrical-conductivity-imparting mechanism 40, the heating mechanism 44 heats and evaporates the getter film material 43, and a getter film is formed on the electrically conductive film of the front substrate 11.

After the electric field process, the front substrate 11 and back substrate 12 are disposed to be opposed to each other within the vacuum atmosphere and are sealed together (ST44). Thus, the vacuum envelope 10 is formed, and the FED is completed.

According to the above-described fourth manufacturing method, the same advantages as with the second manufacturing method can be obtained.

Next, a fifth manufacturing method for manufacturing the FED with the above-described structure is described with reference to a flow chart of FIG. 9. A detailed description of the same steps as have been described in connection with the first manufacturing method is omitted here.

To start with, there are prepared a front substrate 11 having the image display surface including the phosphor screen 15 and metal back 20, and a back substrate 12 having the electron emission elements 18. Within a vacuum atmosphere, an electrically conductive film is formed on the major surface of the front substrate 11 (ST51).

Specifically, the vacuum chamber 30 is evacuated to a desired degree of vacuum. The front substrate 11 is transferred into the vacuum chamber 30 by the substrate transfer mechanism 50. The front substrate 11 is set at the electrical-conductivity-imparting process position PS2. At this time, at the electrical-conductivity-imparting process position PS2, the front substrate 11 is disposed such that its major surface having the image display surface is opposed to the electrical-conductivity-imparting process mechanism 40. In the electrical-conductivity-imparting mechanism 40, the heating mechanism 44 heats and evaporates the electrically conductive film material 42, and an electrically conductive film is formed on the major surface of the front substrate 11. Thereby, factors of generation of discharge, such as non-conductive foreign matter, dust, etc. remaining on the major surface of the front substrate 11, can be made electrically conductive.

Subsequently, within the vacuum chamber 30, the front substrate 11 is transferred by the substrate transfer mechanism 50 and set at the electric field process position PS1. The electrically conductive film, which is formed on the major surface of the front substrate 11, is disposed to be opposed to the processing electrode 34. Further, a potential difference is applied between the front substrate 11 and the processing electrode 34, and an electric field is generated. Thus, the major surface of the front substrate 11 having the electrically conductive film is subjected to an electric field process (ST52). By this first electric field process, factors of generation of discharge, which adhere to the major surface of the front substrate 11 when the front substrate 11 is put in the vacuum chamber 30, are removed. In addition, factors of generation of discharge, which adhere to the major surface of the front substrate 11, such as dust occurring in the electrically conductive film forming step (ST51) and substance floating in the vacuum chamber 30, can be removed.

Subsequently, in the vacuum atmosphere, a getter film is formed on the electrically conductive film of the front substrate 11 (“getter flash”) (ST53). Specifically, the front substrate 11 is transferred by the substrate transfer mechanism 50 and disposed at the electrical-conductivity-imparting process position PS2. In the electrical-conductivity-imparting mechanism 40, the heating mechanism 44 heats and evaporates the getter film material 43, and a getter film is formed on the electrically conductive film of the front substrate 11.

Following the above, within the vacuum chamber 30, the front substrate 11 is transferred by the substrate transfer mechanism 50 and set at the electric field process position PS1. The getter film, which is formed on the major surface of the front substrate 11, is disposed to be opposed to the processing electrode 34. Further, a potential difference is applied between the front substrate 11 and the processing electrode 34, and an electric field is generated. Thus, the major surface of the front substrate 11 having the getter film is subjected to an electric field process (ST54). By this second electric field process, factors of generation of discharge, which adhere to the major surface of the front substrate 11 when the front substrate 11 is put in the vacuum chamber 30, are removed. In addition, factors of generation of discharge, which adhere to the major surface of the front substrate 11, such as dust occurring in the getter film forming step (ST53) and substance floating in the vacuum chamber 30, can be removed.

After the second electric field process, the front substrate 11 and back substrate 12 are disposed to be opposed to each other within the vacuum atmosphere and are sealed together (ST55). Thus, the vacuum envelope 10 is formed, and the FED is completed.

According to the above-described fifth manufacturing method, the same advantages as with the second manufacturing method can be obtained.

According to the second to fifth manufacturing methods, the prepared front substrate 11 is immediately transferred to the electrical-conductivity-imparting process position PS2, and the electrically conductive thin film, such as the electrically conductive film or getter film, is formed on the major surface thereof. Alternatively, prior to this step, the front substrate 11 may be transferred to the electric field process position PS1 and the electric field process may be performed. Thereby, factors of generation of discharge, which are electrically conductive at the time the front substrate 11 is put in the vacuum chamber 30, can be removed, and the withstand voltage characteristics can further be improved.

Prior to the step of sealing the front substrate 11 and back substrate 12 together, it is possible to add an electric field process step for the back substrate 12, in which the major surface (having the electron emission elements) of the back substrate 12 is disposed to be opposed to the processing electrode 34 and an electric field is applied between the back substrate 12 and processing electrode 34. In this case, a high resistance film may be used as an electrically conductive film, which is to be formed on the major surface of the back substrate 12 in order to make factors of generation of discharge electrically conductive. Thereby, non-conductive factors of generation of discharge can be made electrically conductive without effect on circuitry, such as application of voltage to wiring lines, etc., and such factors can be eliminated by the electric field process. Moreover, with the formation of the high resistance film, discharge at the time of operation of the FED can advantageously be suppressed.

The electric field process, which follows the formation of the electrically conductive thin film, such as the electrically conductive film or getter film, on the major surface of the front substrate 11, may be performed at either the electric field process position PS1 or the electric field process position PS3. The second to fifth manufacturing methods can be performed by either the manufacturing apparatus shown in FIG. 3 or the manufacturing apparatus shown in FIG. 4.

In the third to fifth manufacturing methods, the getter film having the gas adsorption capability is formed on the front substrate 11. Since the getter film is the electrically conductive thin film, it may be used in order to make the non-conductive factors of generation of discharge electrically conductive. In this case, however, in the subsequent electric field process, the getter film would be removed from the front substrate together with the factors of generation of discharge. Consequently, the residual amount of the getter film after the completion of the FED would decrease, leading to deterioration in the gas adsorption capability.

In the case where the gas adsorption capability of the getter film is to be fully secured, it is desirable, as described in connection with the fourth manufacturing method, to make electrically conductive the factors of generation of discharge on the front substrate 11 by forming the electrically conductive film, to form the getter film following the removable of the factors of generation of discharge by the electric field process, and to perform no electric field process thereafter.

In this case, if the factors of generation of discharge, such as foreign matter adhering to the front substrate and useless projections, etc., which are formed during the fabrication process, can exactly be removed by the electric field process and, moreover, if no dust occurs at the time of subsequent formation of the getter film, for example, by upward getter flash of the getter film material that is situated below the front substrate, and there are no other factors of generation of discharge adhering to the front substrate, the withstand voltage characteristics of the FED can sufficiently be improved at this process stage.

Regardless of the presence/absence of electrical conductivity, the factors of generation of discharge, which are present on the front substrate, can be removed by a single electric field process which is performed following the formation of the electrically conductive film or getter film. However, if the efficiency of the electric field process with high reliability is to be obtained by constantly keeping the surface of the front substrate in the clean condition, it is desirable, as described in connection with the third and fifth manufacturing methods, to perform the electric field process prior to the formation of the electrically conductive film or getter film, thereby removing the factors of generation of discharge which are made electrically conductive in advance, such as foreign matter, useless projections formed during the fabrication step, and phosphor and metal back with low adhesion, and to perform the electric field process once again after the formation of the electrically conductive film and getter film, thereby removing the factors of generation of discharge, such as dust occurring during evaporation-deposition of the film, or foreign matter which has been made electrically conductive.

If the factors of generation of discharge is not completely removed by the single electric field process, it is possible that the factors can completely be removed by a second electric field process. From the standpoint of reliability, too, it is desirable to perform a plurality of electric field processes, as in the fifth manufacturing method.

In fact, according to the fourth manufacturing method, the electric field process was performed after the formation of the electrically conductive film, and the withstand voltage characteristics of the FED having the getter film, which was subsequently formed, were evaluated. It was found that withstand voltage characteristics of 11 kV, which are sufficiently excellent in consideration of high-voltage specifications necessary for the operation of the FED, were obtained. When the electric field process was not performed after the formation of the electrically conductive film, the withstand voltage characteristics of the FED were 2 kV, which fail to meet the high-voltage specifications.

In addition, the first electric field process was performed after the formation of the electrically conductive film, and the second electric field process was performed after the formation of the getter film. The withstand voltage characteristics of the FED, which was thus obtained, were evaluated. It was found that further excellent withstand voltage characteristics of 13 kV were obtained, and the reliability at the time of operation of the FED was successfully enhanced.

As has been described above, according to the manufacturing methods of the image display device and the manufacturing apparatuses of the image display device according to the embodiments, the substrates with very small factors of generation of discharge can be fabricated. The image display device having a long lifetime, excellent withstand voltage characteristics and high display performance and reliability can be manufactured.

The present invention is not limited to the above-described embodiments. At the stage of practicing the invention, various embodiments may be made by modifying the structural elements without departing from the spirit of the invention. Structural elements disclosed in the embodiments may properly be combined, and various inventions may be made. For example, some structural elements may be omitted from the embodiments. Moreover, structural elements in different embodiments may properly be combined.

For example, in the above-described embodiments, in the electric field process, the processing electrode 34 is grounded, and a voltage is applied to the to-be-processed substrate 33. Conversely, the to-be-processed substrate 33 may be grounded, and a voltage may be applied to the processing electrode 34.

In the above-described embodiments, in the manufacturing apparatus for use in the electric field process, as shown in FIG. 3 and FIG. 4, the processing electrode 34 has an elongated rectangular shape. The invention, however, is not limited to these embodiments. For example, the processing electrode 34 may be a plate-shaped electrode having a larger size than the to-be-processed substrate 33, and the electric field process may be executed at a time, without moving the processing electrode 34. Further, the to-be-processed substrate 33 may be moved relative to the processing electrode 34, without changing the size of the processing electrode 34 or moving the processing electrode.

In the above-described embodiments, the electrically conductive film material and the getter film material, which are disposed vertically downward of the to-be-processed substrate, are evaporated in the vertically upward direction. This reduces the possibility that dust, which occurs in the electrically conductive film formation step and the getter film formation step, may adhere to the to-be-processed substrate. However, the positional relationship between the to-be-processed substrate and the electrically conductive film material and getter film material is not limited to the embodiments. The positional relationship between the mutually opposed to-be-processed substrate and the electrically conductive film material and getter film material may be set in any direction.

In the above-described embodiments, both the front substrate and the back substrate are subjected to the electric field process within the vacuum atmosphere. However, the image display device with improved withstand voltage characteristics can be obtained if at least one of the substrates is subjected to the electric field process. Moreover, needless to say, the present invention is applicable to the manufacture of not only the FED, but also other image display devices such as plasma display panels.

The present invention can provide a method of manufacturing an image display device and an apparatus for manufacturing an image display device, which can achieve excellent withstand voltage characteristics and improve display performance and reliability.

What is claimed is:

1. A manufacturing method of an image display device including a front substrate having an image display surface, and a back substrate having electron emission elements which emit electrons toward the image display surface, comprising:
an electrical-conductivity-imparting process step of imparting electrical conductivity to a to-be-processed substrate, which is at least one of the front substrate and the back substrate, within a vacuum atmosphere;
an electric field process step of disposing a major surface of the to-be-processed substrate with the electrical conductivity to be opposed to a processing electrode, and applying an electric field between the to-be-processed substrate and the processing electrode; and
a sealing step of sealing together the front substrate and the back substrate following the electric field process step in a state in which the front substrate and the back substrate are disposed to be opposed to each other within the vacuum atmosphere.

2. The manufacturing method of an image display device, according to claim 1, wherein in the electrical-conductivity-imparting process step, an electrically conductive film is formed on the major surface of the to-be-processed substrate.

3. The manufacturing method of an image display device, according to claim 2, wherein in the electrical-conductivity-imparting process step, the electrically conductive film is formed by evaporating an electrically conductive film material, which is disposed to be opposed to the major surface of the to-be-processed substrate, within the vacuum atmosphere.

4. The manufacturing method of an image display device, according to claim 1, wherein in the electrical-conductivity-imparting process step, a getter film is formed on the major surface of the to-be-processed substrate.

5. The manufacturing method of an image display device, according to claim 4, wherein in the electrical-conductivity-imparting process step, the getter film is formed by evaporating a getter film material, which is disposed to be opposed to the major surface of the to-be-processed substrate, within the vacuum atmosphere.

6. A manufacturing method of an image display device including a front substrate having an image display surface, and a back substrate having electron emission elements which emit electrons toward the image display surface, comprising:
an electrically conductive thin film forming step of forming a thin film having electrical conductivity on a major surface of the front substrate within a vacuum atmosphere;
an electric field process step of disposing the electrically conductive thin film, which is formed on the major surface of the front substrate, to be opposed to a processing electrode, and applying an electric field between the front substrate and the processing electrode; and
a sealing step of sealing together the front substrate and the back substrate following the electric field process step in a state in which the front substrate and the back substrate are disposed to be opposed to each other within the vacuum atmosphere.

7. A manufacturing method of an image display device including a front substrate having an image display surface, and a back substrate having electron emission elements which emit electrons toward the image display surface, comprising:
an electrically conductive film forming step of forming an electrically conductive film on a major surface of the front substrate within a vacuum atmosphere;
a getter film forming step of forming a getter film on the electrically conductive film of the front substrate within the vacuum atmosphere;
an electric field process step of disposing the getter film, which is formed on the major surface of the front substrate, to be opposed to a processing electrode, and applying an electric field between the front substrate and the processing electrode; and
a sealing step of sealing together the front substrate and the back substrate following the electric field process step in a state in which the front substrate and the back substrate are disposed to be opposed to each other within the vacuum atmosphere.

8. A manufacturing method of an image display device including a front substrate having an image display surface, and a back substrate having electron emission elements which emit electrons toward the image display surface, comprising:
an electrically conductive film forming step of forming an electrically conductive film on a major surface of the front substrate within a vacuum atmosphere;
an electric field process step of disposing the electrically conductive film, which is formed on the major surface of the front substrate, to be opposed to a processing electrode, and applying an electric field between the front substrate and the processing electrode;
a getter film forming step of forming, following the electric field process step, a getter film on the electrically conductive film of the front substrate within the vacuum atmosphere; and
a sealing step of sealing together the front substrate and the back substrate following the getter film forming step in a state in which the front substrate and the back substrate are disposed to be opposed to each other within the vacuum atmosphere.

9. A manufacturing method of an image display device including a front substrate having an image display surface, and a back substrate having electron emission elements which emit electrons toward the image display surface, comprising:
an electrically conductive film forming step of forming an electrically conductive film on a major surface of the front substrate within a vacuum atmosphere;
a first electric field process step of disposing the electrically conductive film, which is formed on the major surface of the front substrate, to be opposed to a processing electrode, and applying an electric field between the front substrate and the processing electrode;
a getter film forming step of forming, following the first electric field process step, a getter film on the electrically conductive film of the front substrate within the vacuum atmosphere;
a second electric field process step of disposing the getter film, which is formed on the major surface of the front substrate, to be opposed to the processing electrode, and applying an electric field between the front substrate and the processing electrode; and
a sealing step of sealing together the front substrate and the back substrate following the second electric field process step in a state in which the front substrate and the back substrate are disposed to be opposed to each other within the vacuum atmosphere.

10. The manufacturing method of an image display device, according to any one of claims 6 to 9, further comprising, prior to the electrically conductive film forming step, an electric field process step of disposing the major surface of the front substrate to be opposed to the processing electrode, and applying an electric field between the front substrate and the processing electrode.

11. The manufacturing method of an image display device, according to any one of claims 6 to 9, further comprising, prior to the sealing step, an electric field process step of disposing a major surface of the back substrate to be opposed to the processing electrode, and applying an electric field between the back substrate and the processing electrode.

12. A manufacturing apparatus of an image display device including a front substrate having an image display surface, and a back substrate having electron emission elements which emit electrons toward the image display surface, comprising:
a vacuum chamber capable of accommodating a to-be-processed substrate, which is at least one of the front substrate and the back substrate;
an evacuation mechanism which evacuates an inside of the vacuum chamber;
a processing electrode which is disposed to be opposed to the to-be-processed substrate within the vacuum chamber;
an electrical-conductivity-imparting process mechanism which imparts electrical conductivity to the to-be-processed substrate; and
an electric field application mechanism which applies an electric field between the to-be-processed substrate, to which the electrical conductivity is imparted by the electrical-conductivity-imparting process mechanism, and the processing electrode.

13. The manufacturing apparatus of an image display device, according to claim 12, wherein the electrical-conductivity-imparting process mechanism includes an electrically conductive film forming device which forms an electrically conductive film on a major surface of the to-be-processed substrate.

14. The manufacturing apparatus of an image display device, according to claim 12 or 13, wherein the electrical-conductivity-imparting process mechanism includes a getter film forming device which forms a getter film on a major surface of the to-be-processed substrate.
